(19) United States
(12) Patent Application Publication
(10) Pub. No.: US 2004/0073935 A1
(43) Pub. Date: Apr. 15, 2004

(54) Background video player, method for processing moving images on background screen using the same, and computer-readable storage medium for storing program for execution of either of them

(76) Inventor: Yong-Hee Kang, Seoul (KR)

Correspondence Address: CANTOR COLBURN, LLP, 55 GRIFFIN ROAD SOUTH, BLOOMFIELD, CT, 06002

(21) Appl. No.: 10/470,855

(22) PCT Filed: Feb. 6, 2002
(86) PCT No.: PCT/KR02/00168

(30) Foreign Application Priority Data
Feb. 6, 2001 (KR) 2001-15680

(51) Int. Cl. H04N 7/173; G09G 5/00; H04N 9/74; H04N 5/445; H04H 9/00; H04N 7/16

(52) U.S. Cl. 725/88; 725/102; 725/14; 348/563; 345/629; 348/586

(57) ABSTRACT

A background video player, a method for processing moving images on a background screen using the same, and a computer-readable storage medium for storing a program for execution of either of them. A background overlay unit (11) receives a play video file list from a play list scheduler (13) in response to a control command from a control panel (14). The overlay unit (11) also detects a used amount of system resources through a system monitor (12), and then reproduces a moving image on the background screen when the detected system resource used amount is not extremely large or the background screen is not fully hidden. A user can program a plurality of moving images in a desired play order. Upon occurrence of a specific event, the user can view a preselected moving image a moving image downloaded over the Internet or a real-time event moving image from a Web camera.

### TECHNICAL FIELD

The present invention relates to a background video player, a method for processing video images (i.e., moving images) on a background screen using the same, and a computer-readable storage medium for storing a program for execution of either of them.

### BACKGROUND ART

In order to meet multimedia requirements of personal computer users, TV cards have been developed and used for a long time to enable the users to view TV programs on their personal computers. TV card products currently most highly recognized in Korea are the ‘On-Air TV’ series by Sasem Co., Ltd. These TV cards have a function of displaying TV images on background screens.

However, such TV cards have a limitation in being incapable of displaying on background screens any video files used in personal computers, such as MPEG files, MOV files, etc., other than video material inputted therein.

A video viewer program, such as SASAMI, is a program for reproduction of video files on a background screen, which is currently opened to the public in Korea. This program, however, has only a simple function of downloading and reproducing a specific video file on the background screen to allow a user to appreciate moving images of the specific video file on the background screen. That is, the video viewer program has been made for the appreciation of one digital movie by the user.

In other words, the above-mentioned conventional arts are disadvantageous in that they reproduce moving images in consideration of no system resources and cannot provide a variety of user-oriented reservation functions such as a function of programming a plurality of moving images in a desired play order, a function of displaying a desired moving image on a background screen under a desired condition, and so forth. As a result, such conventional arts have difficulty in implementing a background video player.

### DISCLOSURE OF THE INVENTION

Therefore, the present invention has been made in view of the above problems, and it is an object of the present invention to provide a background video player for monitoring system resources to selectively provide background moving images so that video files reproducible in a personal computer can be executed on a background screen, a method for processing moving images on a background screen using the same, and a computer-readable storage medium for storing a program for execution of either of them.

It is another object of the present invention to provide a background video player for monitoring system resources to selectively provide background moving images, performing a scheduling function to allow a user to view a desired moving image on a background screen at a desired time and displaying a desired moving image on the background screen upon occurrence of a specific event, so that video files reproducible in a personal computer can be executed on the background screen, a method for processing moving images on a background screen using the same, and a computer-readable storage medium for storing a program for execution of either of them.

In accordance with one aspect of the present invention, the above and other objects can be accomplished by the provision of a background video player comprising a background overlay unit for overlaying and reproducing a specific moving image on a background screen; a system monitor for continuously monitoring system resources to detect a used amount of the system resources and suspend or resume the reproduction of the specific moving image on the background screen in accordance with the detected result; and a control panel for generating a plurality of control commands, the control commands including a play command, a stop command and a pause command.

Preferably, the background video player may further comprise a play list scheduler for sequentially reproducing a list of play files defined by a user and changing play files at reserved times.

Preferably, the background video player may further comprise an event processor for, when an event reservation function is set by the user, communicating with a video service server to determine whether an event has occurred, and then executing a preselected moving image in a computer of the user if the event has occurred.

The event processor may download and execute a desired moving image from the video service server if there is no preselected moving image in the user's computer.

Alternatively, the event processor may download and execute a desired moving image from a Web camera in real time if there is no preselected moving image in the user's computer.

Preferably, the background video player may further comprise a Web access unit for allowing the user to gain access to the video service server and, generating a sampled moving image streaming command such that the user simply previews video files existing in the video service server and transmitting the sampled moving image streaming command to said video service server.

In accordance with another aspect of the present invention, there is provided a method for processing moving images on a background screen using a background video player, comprising the steps of a) creating a sequential play list of video files to be reproduced; b) periodically checking a used state of system resources to determine whether the system is in a reproducible state; and c) sequentially reproducing the video files according to the sequential play list on the background screen if the system is determined to be in the reproducible state at the step b).

In accordance with a further aspect of the present invention, there is provided a method for processing moving images on a background screen using a background video player, comprising the steps of a) creating a sequential play list of video files to be reproduced; b) creating a reserved play list of video files to be executed at a specific time; c) periodically checking a used state of system resources to determine whether the system is in a reproducible state; d) determining whether a current time is a reserved play time; and e) reproducing the video files according to the reserved play list on the background screen if the system is determined to be in the reproducible state at the step c) and if the current time is determined to be the reserved play time at the step d), and sequentially reproducing the video files according to the sequential play list if the system is determined to be in the reproducible state at the step c) and if the current time is determined not to be the reserved play time at the step d).

In accordance with a further aspect of the present invention, there is provided a method for processing moving images on a background screen using a background video player, comprising the steps of a) gaining access to a video service server; b) creating a sequential play list of video files to be reproduced, wherein said video files are to be transferred from said server; c) periodically checking a used state of system resources to determine whether the system is in a reproducible state; and d) sequentially reproducing the video files according to the sequential play list on the background screen if the system is determined to be in the reproducible state at the step c).

In accordance with a further aspect of the present invention, there is provided a method for processing moving images on a background screen using a background video player, comprising the steps of a) gaining access to a video service server; b) creating a sequential play list of video files to be reproduced, wherein said video files are to be transferred from said server; c) creating a reserved play list of video files to be executed at a specific time, wherein said video files are to be transferred from said server; d) periodically checking a used state of system resources to determine whether the system is in a reproducible state; e) determining whether a current time is a reserved play time; and f) reproducing the video files according to the reserved play list on the background screen if the system is determined to be in the reproducible state at the step d) and if the current time is determined to be the reserved play time at the step e), and sequentially reproducing the video files according to the sequential play list if the system is determined to be in the reproducible state at the step d) and if the current time is determined not to be the reserved play time at the step e).

In accordance with a further aspect of the present invention, there is provided a method for processing moving images on a background screen using a background video player, comprising the steps of a) gaining access to a video service server; b) selecting a list of sequential channels with respect to ones to be run, among a plurality of Web cameras which are connected to the server to store moving images in the server in real time; c) periodically checking a used state of system resources to determine whether the system is in a reproducible state; and d) sequentially reproducing video files on the background screen according to the sequential channel list if the system is determined to be in the reproducible state at the step c).

In accordance with another aspect of the present invention, there is provided a method for processing moving images on a background screen using a background video player, comprising the steps of a) gaining access to a video service server; b) selecting a list of sequential channels with respect to ones to be run, among a plurality of Web cameras which are connected to the server to store moving images in the server in real time; c) selecting a list of reserved channels with respect to ones to be run at a specific time, among the Web cameras connected to the server; d) periodically checking a used state of system resources to determine whether the system is in a reproducible state; e) determining whether a current time is a reserved play time; and f) reproducing video files on the background screen according to the reserved channel list if the system is determined to be in the reproducible state at the step d) and if the current time is determined to be the reserved play time at the step e), and sequentially reproducing video files on the background screen according to the sequential channel list if the system is determined to be in the reproducible state at the step d) and if the current time is determined not to be the reserved play time at the step e).

In accordance with yet another aspect of the present invention, there is provided a method for processing moving images on a background screen using a background video player, comprising the steps of a) connecting a personal computer equipped with a video camera to a video service server; b) requesting the video service server to connect the personal computer to a remote personal computer equipped with another video camera; c) receiving moving images from the video camera of the remote personal computer in real time if the video service server interconnects the personal computers in response to the connection request; d) periodically checking a used state of system resources to determine whether the system is in a reproducible state; and e) reproducing a stream of the received moving images on the background screen if the system is determined to be in the reproducible state at the step d).

Preferably, the method may further comprise the step of reproducing a predetermined still image if the system is determined not to be in the reproducible state.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a block diagram showing the construction of a background video player in accordance with the present invention;

FIG. 2 is a flow chart illustrating a method for processing moving images on a background screen using the background video player in accordance with a first embodiment of the present invention;

FIG. 3 is a flow chart illustrating a method for processing moving images on a background screen using the background video player in accordance with a second embodiment of the present invention;

FIG. 4 is a flow chart illustrating a method for processing moving images on a background screen using the background video player in accordance with a third embodiment of the present invention;

FIG. 5 is a flow chart illustrating a method for processing moving images on a background screen using the background video player in accordance with a fourth embodiment of the present invention;

FIG. 6 is a flow chart illustrating a method for processing moving images on a background screen using the background video player in accordance with a fifth embodiment of the present invention;

FIG. 7 is a flow chart illustrating a method for processing moving images on a background screen using the background video player in accordance with a sixth embodiment of the present invention; and

FIG. 8 is a flow chart illustrating a method for processing moving images on a background screen using the background video player in accordance with a seventh embodiment of the present invention.

### BEST MODE FOR CARRYING OUT THE INVENTION

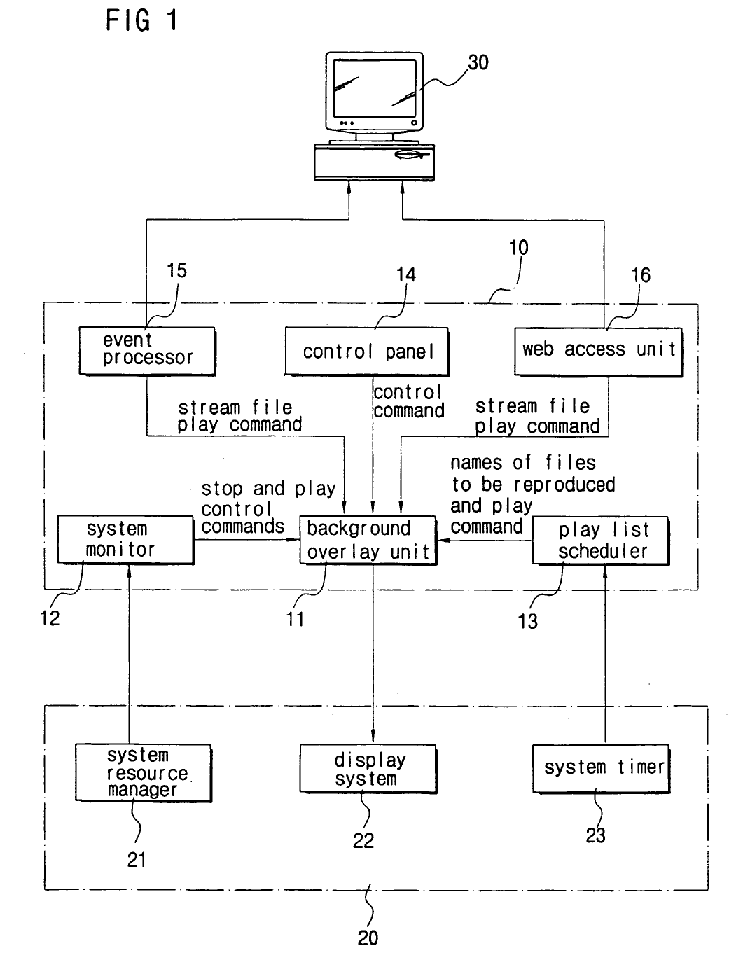

With reference to FIG. 1, there is shown in block form the construction of a background video player in accordance with the present invention, which is denoted by the reference numeral 10.

As shown in FIG. 1, the background video player 10 comprises a background overlay unit 11, a system monitor 12, a play list scheduler 13 and a control panel 14. The background video player 10 further comprises an event processor 15 and a Web access unit 16.

In detail, the background overlay unit 11 generates an overlay/reproduction signal in response to output signals from the system monitor 12, play list scheduler 13, event processor 15 and Web access unit 16 and a control signal from the control panel 14 and outputs the generated overlay/reproduction signal to a display system 22 in an operating system 20 such that a specific moving image is overlaid and reproduced on a background screen.

A detailed description will hereinafter be given of the operation of the overlay unit 11 for reproducing a moving image on the background screen. First, a predetermined image area of the background screen is filled with a color which is limitedly used. Thereafter, for video reproduction, a moving image is displayed on only the predetermined image area of the background screen by means of an overlay mixer of a VGA card.

As a result, the moving image to be reproduced is combined with the background screen in such a manner that the predetermined image area of the screen disappears and the moving image appears in the place of the image area. This combination is an application of the general principle of a Chroma key. Because the predetermined image area of the background screen is replaced with pixels having accurate digital color codes, a finer Chroma key effect can be obtained.

The above Chroma key effect can be supported by low-level VGA driver functions of most up-to-date models of VGA cards, for example, a specific video control function of Direct-X by Microsoft Corporation.

The system monitor 12 detects a used amount of system resources from a system resource manager 21 in the operating system 20, and then suspends the reproduction of a moving image on the background screen when the detected system resource used amount is extremely large or the background screen is fully hidden. Thereafter, if the system enters a reproducible state, then the system monitor 12 resumes the moving image reproduction. To this end, the system monitor 12 continuously monitors the system resources and transfers stop and play control commands to the background overlay unit 11 in accordance with the monitored results.

The play list scheduler 13 sequentially reproduces a list of play files defined by a user with timing of a system timer 23 in the operating system 20 and changes play files at reserved times. To this end, the play list scheduler 13 transfers a sequential play file list and a reserved play file list to the background overlay unit 11.

The control panel 14 transfers control commands, such as a play command, stop command, pause command, etc., to the background overlay unit 11. The control panel 14 is turned on/off in response to a corresponding key being repeatedly entered, such that it alternately appears and disappears on the background screen.

When an event reservation function is set by the user, the event processor 15 periodically communicates with a video service server 30, which provides moving images, to determine whether an event has occurred. In the case where an event has occurred, the event processor 15 transfers to the background overlay unit 11 a command for display of a preselected moving image, or a command for streaming of moving images stored in the server or real-time event moving images from a Web camera installed in the server.

On the other hand, when there is no preselected moving image, the event processor 15 downloads and executes a 0.0 desired moving image from the service server, or in real time downloads and executes a desired moving image from the Web camera.

The Web access unit 16 allows the user to gain access to the video service server 30. The Web access unit 16 further functions to transfer a sampled moving image streaming command to the background overlay unit 11 such that the user simply previews video files existing in the video service server.

As described above, in the background video player 10 according to the present invention, the background overlay unit 11 receives a play video file list from the play list scheduler 13 in response to a control command from the control panel 14. The overlay unit 11 also detects a used amount of system resources through the system monitor 12, and then reproduces a moving image on the background screen when the detected system resource used amount is not extremely large or the background screen is not fully hidden. On the contrary, in the case where the detected system resource used amount is extremely large or the background screen is fully hidden, the background overlay unit 11 suspends the reproduction of a moving image on the background screen.

On the other hand, when the event reservation function is set through the play list scheduler 13 by the user, the event processor 15 periodically communicates with the video service server 30, which provides moving images, to determine whether an event has occurred. Upon occurrence of an event, the event processor 15 transfers to the background overlay unit 11 a command for display of a preselected moving image, or a command for streaming of moving images stored in the video service server 30 or real-time event moving images from the Web camera, such that the overlay unit 11 reproduces a moving image on the background screen.

In the case where the user accesses the video service server 30 and selects video files existing in the server, the Web access unit 16 transfers the sampled moving image streaming command to the background overlay unit 11 to reproduce moving images on the background screen such that the user simply previews the selected video files.

The control panel 14 is operated by the user to transfer the control commands, such as the play command, stop command, pause command, etc., to the background overlay unit 11. The control panel 14 is of such a popup dialogue type that it is turned on/off in response to a corresponding key being repeatedly entered, so as to alternately appear and disappear on the background screen. As a result, the control panel 14 can appear or disappear on the background screen by the clicking of, for example, a right button of a mouse by the user.

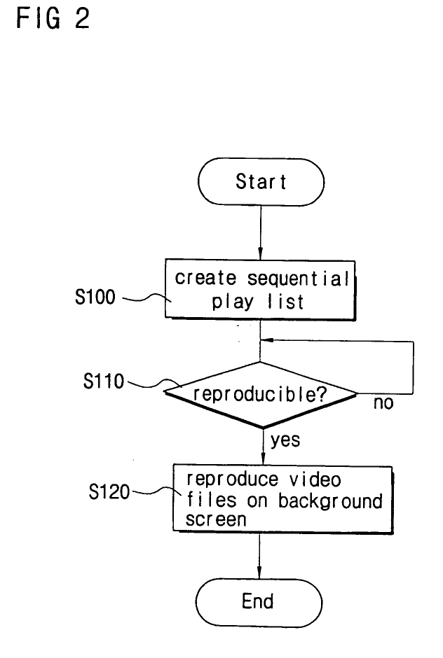

FIG. 2 is a flow chart illustrating a method for processing moving images on a background screen using the background video player in accordance with a first embodiment of the present invention.

As shown in FIG. 2, the moving image processing method comprises a sequential play list creation step S100, a system resource used state determination step S110 and a play step S120.

A sequential play list of video files to be reproduced is created at the sequential play list creation step S100 and a used state of system resources is periodically checked at the system resource used state determination step S110 to determine whether the system is in a reproducible state. If the system is determined to be in the reproducible state at the system resource used state determination step S110, the video files according to the sequential play list are sequentially reproduced on the background screen at the play step S120.

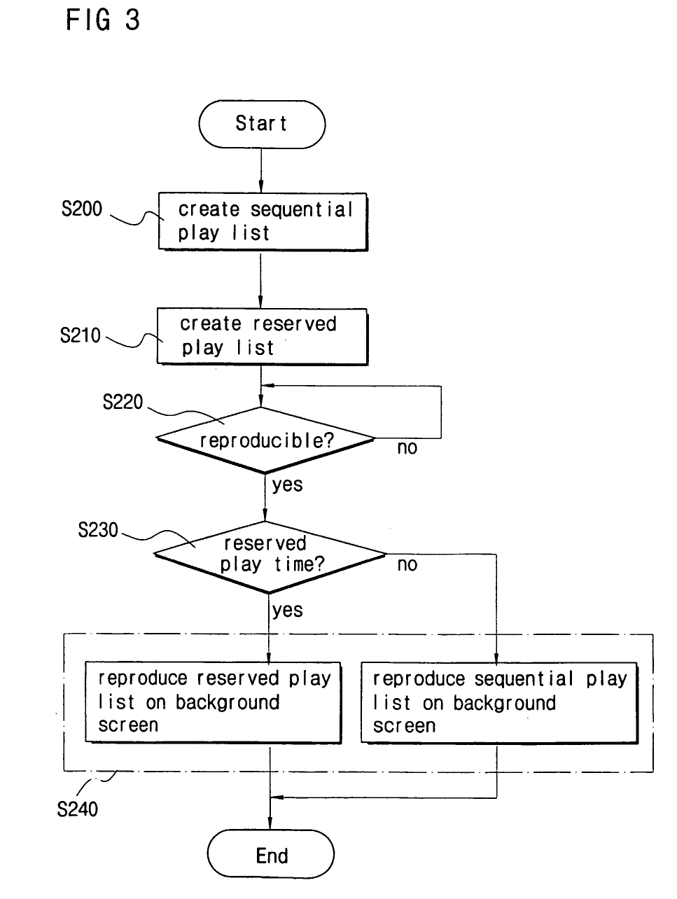

FIG. 3 is a flow chart illustrating a method for processing moving images on a background screen using the background video player in accordance with a second embodiment of the present invention.

As shown in FIG. 3, the moving image processing method comprises a sequential play list creation step S200, a reserved play list creation step S210, a system resource used state determination step S220, a reserved time determination step S230 and a play step S240.

A sequential play list of video files to be reproduced is created at the sequential play list creation step S200 and a reserved play list of video files to be executed at a specific time is created at the reserved play list creation step S210. A used state of system resources is periodically checked at the system resource used state determination step S220 to determine whether the system is in a reproducible state. At the reserved time determination step S230, a determination is made as to whether the current time is a reserved play time. If the system is determined to be in the reproducible state at the system resource used state determination step S220 and if the current time is determined to be the reserved play time at the reserved time determination step S230, the video files according to the reserved play list are reproduced on the background screen at the play step S240.

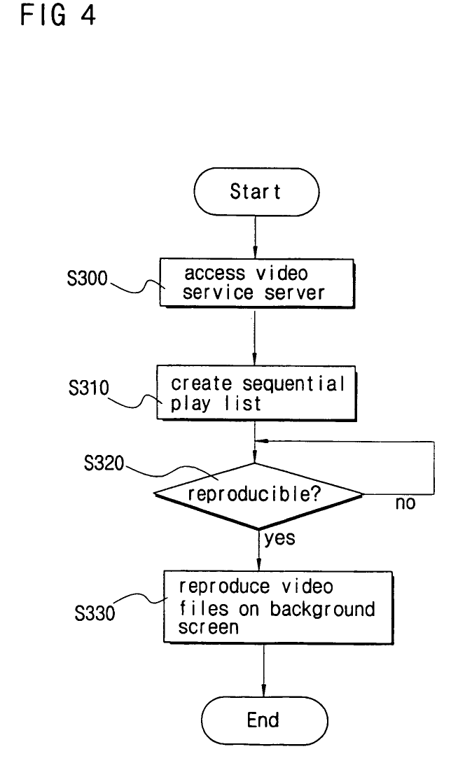

FIG. 4 is a flow chart illustrating a method for processing moving images on a background screen using the background video player in accordance with a third embodiment of the present invention.

As shown in FIG. 4, the moving image processing method comprises an access step S300, a sequential play list creation step S310, a system resource used state determination step S320 and a play step S330.

A user gains access to a video service server over the Internet at the access step S300. A sequential play list of video files to be reproduced, which are to be transferred from said server, is created at the sequential play list creation step S310 and a used state of system resources is periodically checked at the system resource used state determination step S320 to determine whether the system is in a reproducible state. If the system is determined to be in the reproducible state at the system resource used state determination step S320, the video files according to the sequential play list are sequentially reproduced on the background screen at the play step S330.

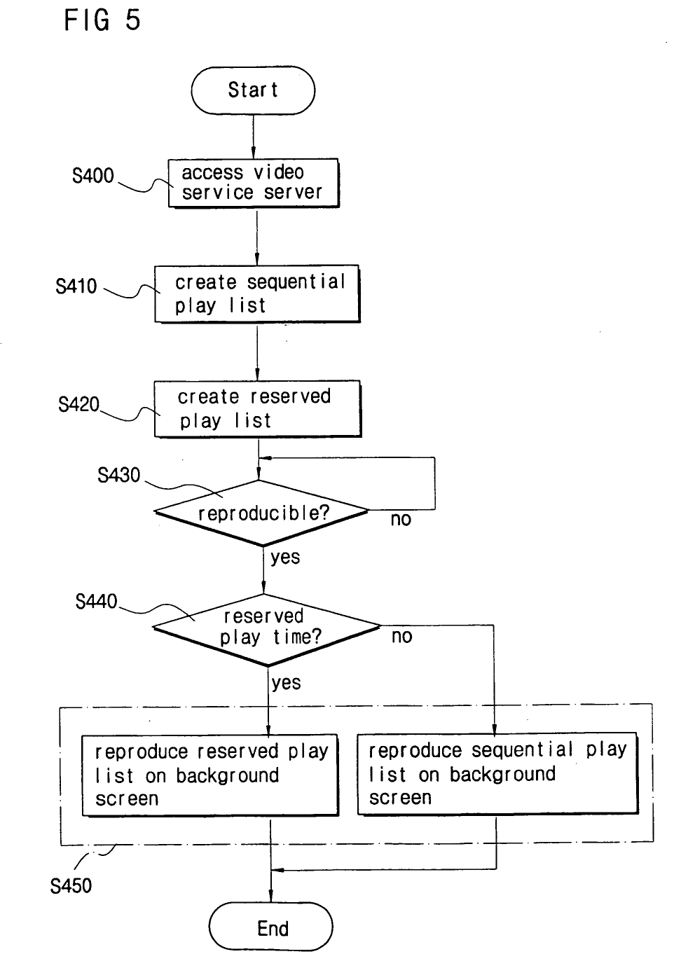

FIG. 5 is a flow chart illustrating a method for processing moving images on a background screen using the background video player in accordance with a fourth embodiment of the present invention.

As shown in FIG. 5, the moving image processing method comprises an access step S400, a sequential play list creation step S410, a reserved play list creation step S420, a system resource used state determination step S430, a reserved time determination step S440 and a play step S450.

At the access step S400, a user gains access to a video service server. A sequential play list of video files to be reproduced, which are to be transferred from said server, is created at the sequential play list creation step S410 and a reserved play list of video files to be executed at a specific time, which are to be transferred from said server, is created at the reserved play list creation step S420. A used state of system resources is periodically checked at the system resource used state determination step S430 to determine whether the system is in a reproducible state. Whether the current time is a reserved play time is determined at the reserved time determination step S440. If the system is determined to be in the reproducible state at the system resource used state determination step S430 and if the current time is determined to be the reserved play time at the reserved time determination step S440, the video files according to the reserved play list are reproduced on the background screen at the play step S450. Alternatively, in the case where the system is determined to be in the reproducible state at the system resource used state determination step S430 and where the current time is determined not to be the reserved play time at the reserved time determination step S440, the video files according to the sequential play list are sequentially reproduced on the background screen at the play step S450.

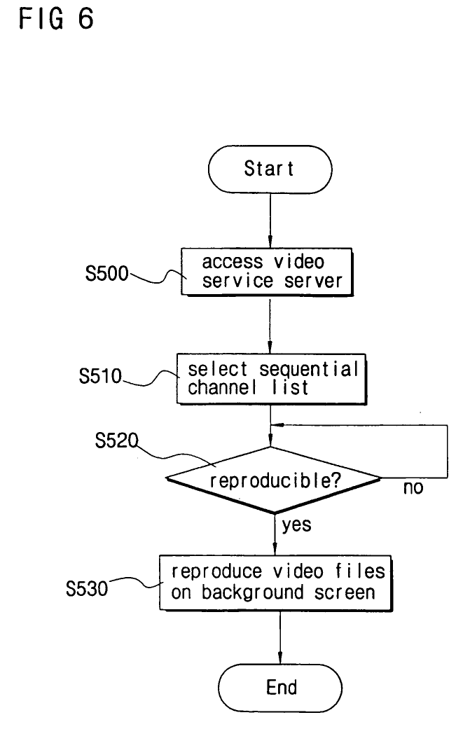

FIG. 6 is a flow chart illustrating a method for processing moving images on a background screen using the background video player in accordance with a fifth embodiment of the present invention.

As shown in FIG. 6, the moving image processing method comprises an access step S500, a sequential channel selection step S510, a system resource used state determination step S520 and a play step S530.

At the access step S500, a user gains access to a video service server. At the sequential channel selection step S510, a list of sequential channels is selected with respect to ones to be run, among a plurality of Web cameras which are connected to the server to store moving images in the server in real time. A used state of system resources is periodically checked at the system resource used state determination step S520 to determine whether the system is in a reproducible state. If the system is determined to be in the reproducible state at the system resource used state determination step S520, video files are sequentially reproduced on the background screen according to the sequential channel list at the play step S530.

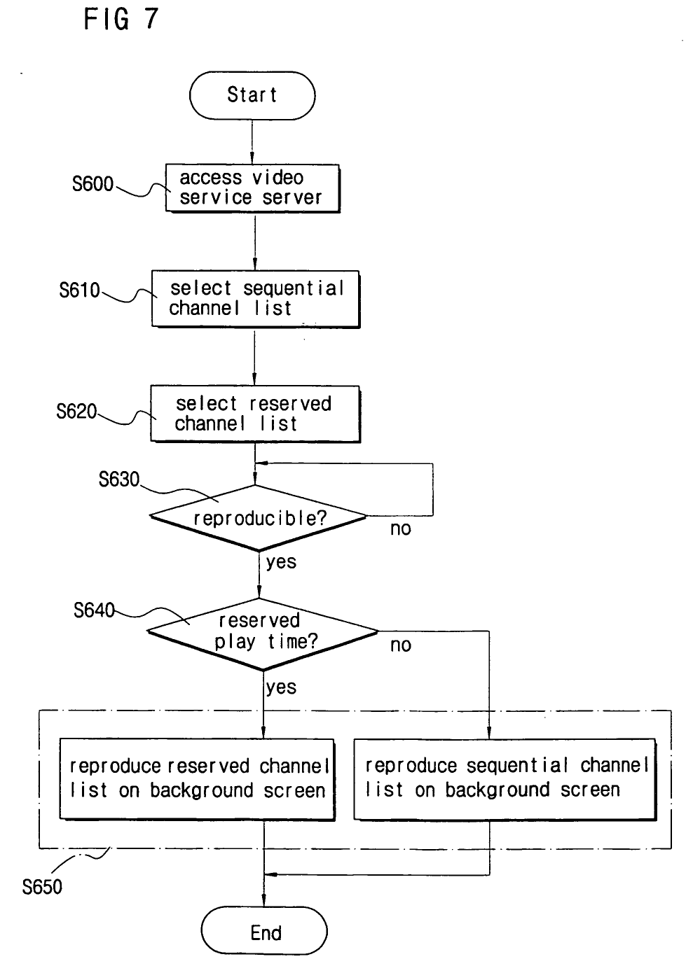

FIG. 7 is a flow chart illustrating a method for processing moving images on a background screen using the background video player in accordance with a sixth embodiment of the present invention.

As shown in FIG. 7, the moving image processing method comprises an access step S600, a sequential channel selection step S610, a reserved channel selection step S620, a system resource used state determination step S630, a reserved time determination step S640 and a play step S650.

A user gains access to a video service server at the access step S600. At the sequential channel selection step S610, a list of sequential channels is selected with respect to ones to be run, among a plurality of Web cameras which are connected to the server to store moving images in the server in real time. At the reserved channel selection step S620, a list of reserved channels is selected with respect to ones to be run at a specific time, among the Web cameras connected to the server. A used state of system resources is periodically checked at the system resource used state determination step S630 to determine whether the system is in a reproducible state. Whether the current time is a reserved play time is determined at the reserved time determination step S640. If the system is determined to be in the reproducible state at the system resource used state determination step S630 and if the current time is determined to be the reserved play time at the reserved time determination step S640, video files are reproduced on the background screen according to the reserved channel list at the play step S650. However, in the case where the system is determined to be in the reproducible state at the system resource used state determination step S630 and where the current time is determined not to be the reserved play time at the reserved time determination step S640, video files are sequentially reproduced on the background screen according to the sequential channel list at the play step S650.

In the fifth and sixth embodiments, moving images sent from different Web cameras may be reproduced on the background screen at the same time in a screen separation manner.

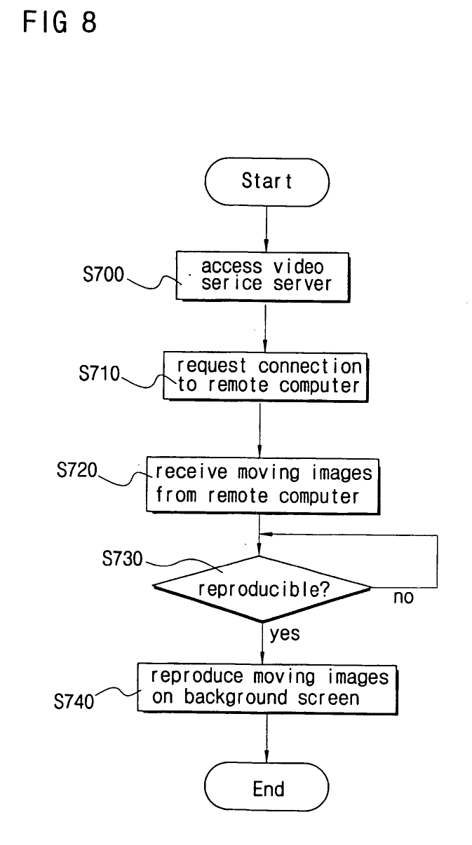

FIG. 8 is a flow chart illustrating a method for processing moving images on a background screen using the background video player in accordance with a seventh embodiment of the present invention.

As shown in FIG. 8, the moving image processing method comprises an access step S700, a connection request step S710, a reception step S720, a system resource used state determination step S730 and a play step S740.

At the access step S700, a user gains access to a video service server over the Internet using his/her personal computer equipped with a video camera. At the connection request step S710, the user requests the video service server to connect his/her personal computer to a remote personal computer equipped with another video camera. If the video service server connects the user's personal computer to the remote personal computer in response to the connection request, the user's personal computer receives moving images from the video camera of the remote personal computer in real time at the reception step S720. A used state of system resources is periodically checked at the system resource used state determination step S730 to determine whether the system is in a reproducible state. If the system is determined to be in the reproducible state at the system resource used state determination step S730, a stream of the received moving images is reproduced on the background screen at the play step S740.

On the other hand, in the moving image processing method using the background video player according to the present invention, if the system is determined not to be in the reproducible state at the system resource used state determination step, a predetermined still image is reproduced on the background screen at the play step such that the system resource use is not overloaded.

The present invention further provides a computer-readable storage medium for storing programs for execution of the background video player and the moving image processing method using the same.

In the present invention, the storage medium is a typical storage unit such as a floppy disk, hard disk, CD-ROM or etc. The execution programs are installed or plugged in a computer through the storage medium to execute in the computer the background video player and the moving image processing method using the same.

With the execution programs installed or plugged in the computer, the background video player and the moving image processing method using the same can attain the above-described objects of the present invention.

### INDUSTRIAL APPLICABILITY

As apparent from the above description, the present invention provides a background video player, and a method for processing video images (i.e., moving images) on a background screen using the same. Only when a user appreciates the background screen, moving images are displayed on the background screen, thereby enabling system resources to be efficiently managed. Further, the user can program a plurality of moving images in a desired play order. Furthermore, a specific event can be reserved to provide the user with a dynamic background image such as a scene of nature.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. A background video player comprising:
a background overlay unit for overlaying and reproducing a specific moving image on a background screen;
a system monitor for continuously monitoring system resources to detect a used amount of the system resources and suspend or resume the reproduction of said specific moving image on said background screen in accordance with the detected result; and
a control panel for generating a plurality of control commands, said control commands including a play command, a stop command and a pause command.

2. The background video player as set forth in claim 1, further comprising a play list scheduler for sequentially reproducing a list of play files defined by a user and changing play files at reserved times.

3. The background video player as set forth in claim 1 or 2, further comprising an event processor for, when an event reservation function is set by the user, communicating with a video service server to determine whether an event has occurred, and then executing a preselected moving image in a computer of the user if the event has occurred.

4. The background video player as set forth in claim 3, wherein said event processor is adapted to download and execute a desired moving image from said video service server if there is no preselected moving image in the user's computer.

5. The background video player as set forth in claim 3, wherein said event processor is adapted to download and execute a desired moving image from a Web camera in real time if there is no preselected moving image in the user's computer.

6. The background video player as set forth in any one of claims 1, 2, 4 and 5, further comprising a Web access unit for allowing the user to gain access to said video service server and, generating a sampled moving image streaming command such that the user simply previews video files existing in said video service server and transmitting the sampled moving image streaming command to said video service server.

7. A computer-readable storage medium for storing a program for execution of the background video player as set forth in any one of claims 1, 2, 4 and 5.

8. A method for processing moving images on a background screen using a background video player, comprising the steps of:
a) creating a sequential play list of video files to be reproduced;
b) periodically checking a used state of system resources to determine whether the system is in a reproducible state; and
c) sequentially reproducing the video files according to said sequential play list on said background screen if the system is determined to be in the reproducible state at said step b).

9. A method for processing moving images on a background screen using a background video player, comprising the steps of:
a) creating a sequential play list of video files to be reproduced;
b) creating a reserved play list of video files to be executed at a specific time;
c) periodically checking a used state of system resources to determine whether the system is in a reproducible state;
d) determining whether a current time is a reserved play time; and
e) reproducing the video files according to said reserved play list on said background screen if the system is determined to be in the reproducible state at said step c) and if the current time is determined to be the reserved play time at said step d), and sequentially reproducing the video files according to said sequential play list if the system is determined to be in the reproducible state at said step c) and if the current time is determined not to be the reserved play time at said step d).

10. A method for processing moving images on a background screen using a background video player, comprising the steps of:
a) gaining access to a video service server;
b) creating a sequential play list of video files to be reproduced, wherein said video files are to be transferred from said server;
c) periodically checking a used state of system resources to determine whether the system is in a reproducible state; and
d) sequentially reproducing the video files according to said sequential play list on said background screen if the system is determined to be in the reproducible state at said step c).

11. A method for processing moving images on a background screen using a background video player, comprising the steps of:
a) gaining access to a video service server;
b) creating a sequential play list of video files to be reproduced, wherein said video files are to be transferred from said server;
c) creating a reserved play list of video files to be executed at a specific time, wherein said video files are to be transferred from said server;
d) periodically checking a used state of system resources to determine whether the system is in a reproducible state;
e) determining whether a current time is a reserved play time; and
f) reproducing the video files according to said reserved play list on said background screen if the system is determined to be in the reproducible state at said step d) and if the current time is determined to be the reserved play time at said step e), and sequentially reproducing the video files according to said sequential play list if the system is determined to be in the reproducible state at said step d) and if the current time is determined not to be the reserved play time at said step e).

12. A method for processing moving images on a background screen using a background video player, comprising the steps of:
a) gaining access to a video service server;
b) selecting a list of sequential channels with respect to ones to be run, among a plurality of Web cameras which are connected to said server to store moving images in said server in real time;
c) periodically checking a used state of system resources to determine whether the system is in a reproducible state; and
d) sequentially reproducing video files on said background screen according to said sequential channel list if the system is determined to be in the reproducible state at said step c).

13. A method for processing moving images on a background screen using a background video player, comprising the steps of:
a) gaining access to a video service server;
b) selecting a list of sequential channels with respect to ones to be run, among a plurality of Web cameras which are connected to said server to store moving images in said server in real time;
c) selecting a list of reserved channels with respect to ones to be run at a specific time, among said Web cameras connected to said server;
d) periodically checking a used state of system resources to determine whether the system is in a reproducible state;
e) determining whether a current time is a reserved play time; and
f) reproducing video files on said background screen according to said reserved channel list if the system is determined to be in the reproducible state at said step d) and if the current time is determined to be the reserved play time at said step e), and sequentially reproducing video files on said background screen according to said sequential channel list if the system is determined to be in the reproducible state at said step d) and if the current time is determined not to be the reserved play time at said step e).

14. A method for processing moving images on a background screen using a background video player, comprising the steps of:
a) connecting a personal computer equipped with a video camera to a video service server;
b) requesting said video service server to connect said personal computer to a remote personal computer equipped with another video camera;
c) receiving moving images from said video camera of said remote personal computer in real time if said video service server interconnects said personal computers in response to the connection request;
d) periodically checking a used state of system resources to determine whether the system is in a reproducible state; and
e) reproducing a stream of the received moving images on said background screen if the system is determined to be in the reproducible state at said step d).

15. The method as set forth in any one of claims 8 to 14, further comprising the step of reproducing a predetermined still image if the system is determined not to be in the reproducible state.

16. A computer-readable storage medium for storing a program for execution of the method as set forth in any one of claims 8 to 14.
